(19) United States
(12) Patent Application Publication
(10) Pub. No.: US 2004/0026193 A1
(43) Pub. Date: Feb. 12, 2004

(54) Slack adjuster torque limited manual adjustment

(76) Inventor: Daniel J. Philpott, Rochester, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/214,636

(22) Filed: Aug. 8, 2002

(51) Int. Cl. F16D 51/00

(52) U.S. Cl. 188/196 V; 188/79.55

(57) ABSTRACT

A slack adjuster for a brake system is provided that includes a housing with a gear disposed in the housing. The gear has outer circumferential teeth. An adjustment assembly is disposed within the housing and includes first and second members adjacent and rotatable relative to one another. The first member has a worm portion engaging the teeth of the gear. The second member includes an end portion, which typically extends through the housing for receiving manual adjustment from a technician using a tool. The technician applies a rotational adjustment input on the end portion for adjusting the position of the gear, which adjusts the length of a brake actuator push rod to within a desired range. A clutch assembly interconnects the first and second members to limit torque transfer from the second member to the first member produced in response to the rotational adjustment input. Preferably, the clutch assembly includes a first clutch permitting torque transfer in one direction and a second clutch permitting torque transfer in the other direction. When a predetermined torque is reached that would otherwise damage the internal components of the slack adjuster, the clutch assembly overruns permitting relative rotational movement between the first and second members.

### BACKGROUND OF THE INVENTION

This invention relates to a slack adjuster for a brake system, and more particularly, the invention relates to a slack adjuster having a manual adjustment member.

Slack adjusters adjust the clearance between the brake lining and the brake drum. When the linings wear, the clearance increases and causes the brake chamber push rod to move a greater distance to apply the brakes. It is desirable to maintain the push rod actuation length within a desired range. Slack adjusters, which may be automatic or manual, reduce the length the rod must move as the clearance increases to maintain the actuation length within the desired range.

Occasionally the slack adjuster must be manually adjusted even for automatic slack adjusters. For manual adjustment, the slack adjuster typically includes an adjuster assembly with an end that extends beyond the adjuster housing. A mechanic or technician rotates the end to manually adjust the slack adjuster. It is possible to apply excessive torque through the end of the adjuster assembly and thus damage the internal components of the slack adjuster. As a result, the internal components of the slack adjuster must be replaced, which is difficult and time consuming. Furthermore, the manual adjustment typically needs to occur in both directions. That is, the brake rod length must be lengthened or shortened to maintain the desired range. Therefore, what is needed is an adjuster assembly for a slack adjuster that prevents excessive torque during manual adjustment preventing damage to the internal components of the adjuster.

### SUMMARY OF THE INVENTION AND ADVANTAGES

The present invention provides a slack adjuster for a brake system including a housing with a gear disposed in the housing. The gear has outer circumferential teeth. An adjustment assembly is disposed within the housing and includes first and second members adjacent and rotatable relative to one another. The first member has a worm portion engaging the teeth of the gear. The second member includes an end portion, which typically extends through the housing for receiving manual adjustment from a technician using a tool. The technician applies a rotational adjustment input on the end portion for adjusting the position of the gear, which adjusts the length of a brake actuator push rod to within a desired range. A clutch assembly interconnects the first and second members to limit torque transfer from the second member to the first member produced in response to the rotational adjustment input. Preferably, the clutch assembly includes a first clutch permitting torque transfer in one direction and a second clutch permitting torque transfer in the other direction. When a predetermined torque is reached that would otherwise damage the internal components of the slack adjuster, the clutch assembly overruns permitting relative rotational movement between the first and second members.

Accordingly, the above invention provides an adjuster assembly for a slack adjuster that prevents excessive torque during manual adjustment preventing damage to the internal components of the adjuster.

### BRIEF DESCRIPTION OF THE DRAWINGS

Other advantages of the present invention can be understood by reference to the following detailed description when considered in connection with the accompanying drawings wherein:

FIG. 1 is a cross-sectional view of a brake system including the present invention slack adjuster;

FIG. 2 is a partially broken cross-sectional view of the present invention adjustment assembly;

FIG. 3 is a cross-sectional view of one clutch of the clutch assembly taken along lines 3-3 in FIG. 2;

FIG. 4 is a cross-sectional view of another clutch of the clutch assembly taken along lines 4-4 in FIG. 2; and

FIG. 5 is a cross-sectional view of another embodiment of a portion of the adjustment assembly.

### DETAILED DESCRIPTION OF THE PREFERRED EMBODIMENT

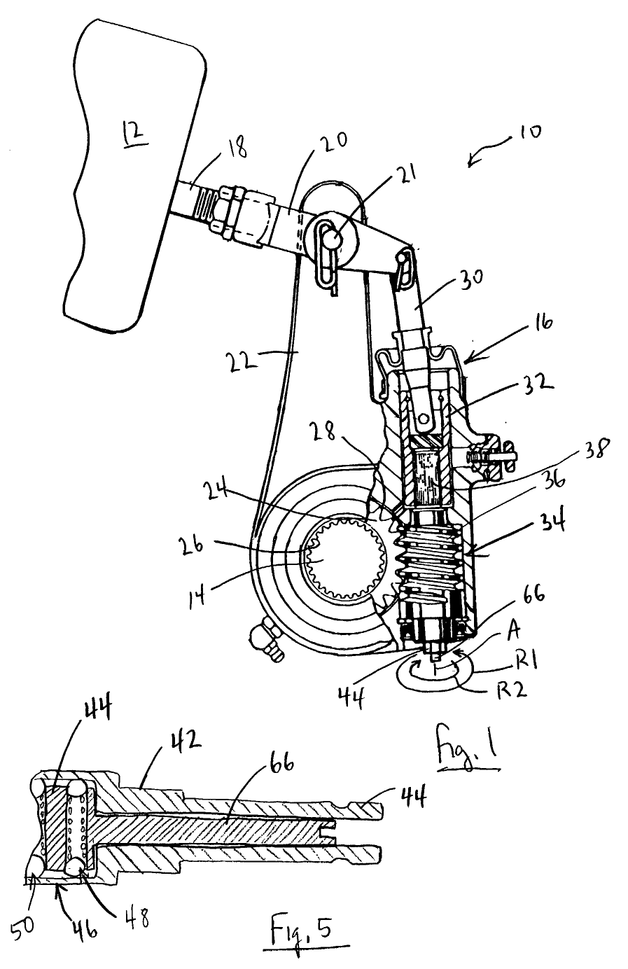

A brake system 10 is shown in FIG. 1. The system 10 includes a brake air chamber 12 coupled to a brake cam shaft 14 through a slack adjuster 16. A push rod 18 extends from the brake chamber 12 to the slack adjuster 16 and is connected to an adjuster housing 22 by a clevis 20 and pin 21 arrangement. Actuation of the brake chamber 12 rotates the cam shaft 14 forcing the brake linings into engagement with the brake drum. As the linings wear, the push rod actuation length increases and the position of the slack adjuster 16 relative to the cam shaft 14. must be adjusted to maintain the push rod 18 within a desired operating range.

Slack adjuster 16 includes a gear 24 disposed within the housing 22. The gear 24 includes internal splines 26 coupling the gear 24 to the cam shaft 14. The gear 24 includes outer circumferential teeth 28 that are used to rotate the gear 24 during automatic and/or manual adjustment of the slack adjuster 16. The slack adjuster 16 depicted is an automatic adjuster. The automatic adjuster includes an actuator rod 30 coupled to the end of the clevis 20. The rod 30 is received in an adjusting sleeve 32 that includes helical grooves on its outer circumference (not shown), as is well known in the art. An adjustment assembly 34 is typically coupled to the actuating sleeve 32 by a spline 38 received within the adjusting sleeve 32. The adjustment assembly 34 includes a worm 36 that engages the outer circumferential teeth 28. Movement of the actuator rod 30 during brake air chamber actuation causes the worm 36 to rotate thereby automatically adjusting the length of the push rod 18, as is well known in the art.

Typically, the slack adjuster 16 has provided for manual adjustment through an end of the adjustment assembly 34 extending through the housing 22. A technician applies a rotational input to the adjustment assembly 34 that rotates the worm 36. However, an undesirably high torque may be placed upon the adjustment assembly 34 and other internal components which may damage the slack adjuster.

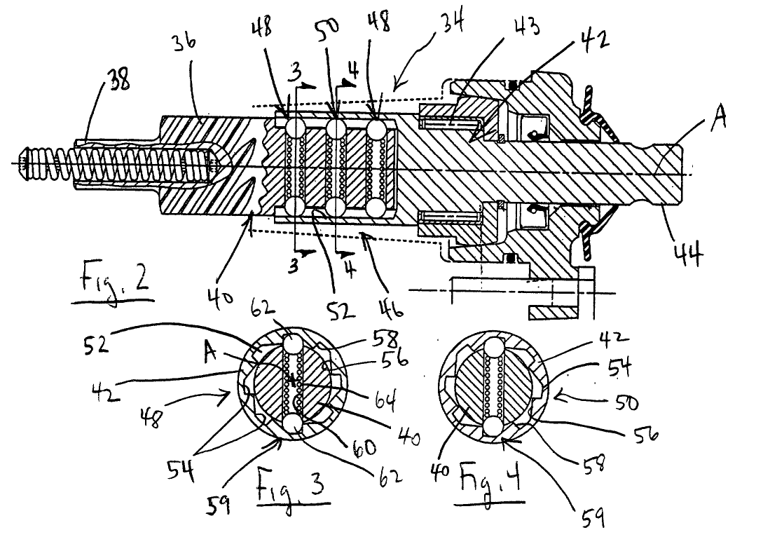

The present invention incorporates an adjustment assembly 34 having a clutch assembly 46, as best shown in FIG. 2. The adjustment assembly 34 includes the first 40 and second 42 members that are rotatable relative to one another with the clutch assembly 46 coupling the first 40 and second 42 members together. The first member 40 includes a worm portion 36 that engages the outer circumferential teeth 28. The second member 42 includes the end portion 44 that extends preferably from the housing 22 for receiving the rotational input from the technician. The second member 42 may be supported in the housing by a bearing 43. The adjustment assembly 34 is rotatable about an adjustment axis A. Since it is often desirable to manually adjust and de-adjust the slack adjuster 16, the clutch assembly 46 preferably includes at least one first clutch 48 transmitting torque in a first direction and at least one second clutch 50 transmitting torque in an opposite direction. The clutches 48 and 50 transmit torque in the desired direction up to a predetermined torque above which the clutch will overrun thereby preventing damaging high torques from being transmitted through the adjustment assembly 34.

Any suitable clutch configuration may be used. One desired clutch configuration is of a configuration shown in FIGS. 3 and 4. The second member 42 may include a cavity 52 with a portion of the first member 40 received within the cavity 52. The cavity 52 of the second member 42 may include a plurality of pockets 54 arranged circumferentially about the cavity 52. The pockets 54 may include ramped surfaces 56 and stops 58. A detent 59 may be supported by the first member 40. The detent 59 may include a hole 60 transverse to the adjustment axis A with opposing balls 62 biased outwardly into engagement with the pockets 54 by spring 64. Referring to FIG. 3, torque is transmitted from the second member 42 to the first member 40 in response to a rotational input on end portion 44. The balls 62 engage the stops 58 and moves the first member 40 in a clockwise direction in response to a clockwise input on end portion 44 that is below a predetermined torque. Once the predetermined torque has been exceeded, the balls 62 will compress the spring 64 and move inwardly to permit the clutch to overrun and allow the second member 42 to move relative to the first member 40.

Conversely, the clutch 50 shown in FIG. 4 moves the first member 40 in a counter clockwise direction in response to a rotational input on the end portion in an counterclockwise direction in the same manner as that described above relative to clutch 48. Referring to FIG. 5, the clutch assembly 46 may be circumvented by providing an adjustment member 66 extending from the first member 40. Providing a rotational adjustment input to the adjustment member 66 will directly rotate the worm portion 36, however, the benefits of the present invention clutch assembly 46 will not be realized. The adjustment member 66 is shown schematically and may be provided in a manner other than that shown.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A slack adjuster for a brake system comprising:
a housing;
a gear disposed within said housing having outer circumferential teeth; and
an adjustment assembly disposed within said housing and including first and second members adjacent and rotatable relative to one another, said first member having a worm portion engaging said teeth and said second member with an end portion for receiving a rotational adjustment input for adjusting the position of said gear, and a clutch assembly interconnecting said first and second members limiting torque transferred from said second member to said first member produced in response to said rotational adjustment input.

2. The slack adjuster according to claim 1, wherein said first and second members are coaxial.

3. The slack adjuster according to claim 2, wherein said first and second members are concentric.

4. The slack adjuster according to claim 1, wherein said clutch assembly includes a first clutch permitting torque transfer in a first rotational direction and preventing torque transfer in a second rotational direction opposite said first rotational direction, and a second clutch permitting torque transfer in said second rotational direction and preventing torque transfer in said first rotational direction.

5. The slack adjuster according to claim 1, wherein said first member includes a spline portion extending from said worm portion for coacting with an actuator rod that automatically adjusts said gear.

6. The slack adjuster according to claim 1, wherein said first member includes an adjustment member for receiving a second rotational adjustment input for overriding said clutch assembly and directly rotating said worm portion to adjust the position of said gear.

7. The slack adjuster according to claim 6, wherein said end portion extends through said housing and said adjustment member is disposed within said end portion.

8. The slack adjuster according to claim 1, wherein said clutch assembly includes a plurality of pockets arranged in said second member and at least one detent supported by said first member engaging said pockets.

9. The slack adjuster according to claim 8, wherein each of said pockets include a ramp and a stop with said detent engaging said stop to transfer torque in response to said rotational adjustment input rotating said first and second members together.

10. The slack adjuster according to claim 9, wherein said detent includes a ball biased by a spring into engagement with said pocket, said ball compressing said spring in response to a predetermined torque permitting said first and second member to rotate relative to one another.

11. A method of manually adjusting a slack adjuster comprising the steps of:
a) manually rotating an adjustment member;
b) rotating a worm coupled to the adjustment member through a clutch assembly;
c) exceeding a predetermined torque on the adjustment member; and
d) overrunning the clutch assembly and discontinuing rotation of the worm.

12. The method according to claim 11, wherein the clutch assembly includes a first clutch permitting torque transfer in a first rotational direction and preventing torque transfer in a second rotational direction opposite the first rotational direction, and a second clutch permitting torque transfer in the second rotational direction and preventing torque transfer in the first rotational direction.

13. The method according to claim 11, including step e) manually rotating a second adjustment member to directly rotate the worm.
